(19) United States
(12) Patent Application Publication
(10) Pub. No.: US 2017/0282680 A1
(43) Pub. Date: Oct. 5, 2017

(54) VEHICULAR REGISTER APPARATUS

(71) Applicants: SHIGERU CO., LTD., Ota-shi (JP); Dr. Schneider Kunststoffwerke GmbH, Kronach-Neuses (DE)

(72) Inventor: Takanori TAJIMA, Ota-shi (JP)

(73) Assignees: SHIGERU CO., LTD., Ota-shi (JP); Dr. Schneider Kunststoffwerke GmbH, Kronach-Neuses (DE)

(21) Appl. No.: 15/471,153

(22) Filed: Mar. 28, 2017

(30) Foreign Application Priority Data
Mar. 31, 2016 (JP) 2016-070027

(51) Int. Cl. B60H 1/00

(52) U.S. Cl. CPC B60H 1/00564; B60H 2001/00092

(57) ABSTRACT

A vehicular register apparatus includes an apparatus body having a ventilation path with a downstream end provided as a blow outlet to a vehicle room. Fins are arranged in the ventilation path. The fins are spaced to each other in a first direction intersecting with an airflow direction. Each of the fins extends in a second direction intersecting with the airflow direction and the first direction. The fins respectively have shaft parts for supporting the fins on the apparatus body. The apparatus body includes guide passages for swingably and slidably supporting the shaft parts. The guide passages are formed so as to be apart in the first direction from each other toward the vehicle room.

### CROSS-REFERENCES TO RELATED APPLICATION(S)

This application is based on and claims priority from Japanese Patent Application No. 2016-070027 filed on Mar. 31, 2016, the entire contents of which are incorporated herein by reference.

### BACKGROUND

### 1. Field of the Invention

The invention relates to a register apparatus for blowing air from an air conditioner to a vehicle room.

### 2. Description of Related Art

JP-A-2007-076481 discloses a register apparatus installed in a vehicular cluster panel (interior panel). The register apparatus includes an apparatus body having a ventilation path, a blow outlet side fin assembly arranged in a blow outlet side of the ventilation path, and a back side fin assembly arranged in the back of the ventilation path. The blow outlet side fin assembly has plural fins spaced in a vertical direction and also extending in a left-right direction in parallel with each other, and a coupling link extending in the vertical direction and rotatably coupled to these fins. The back side fin assembly has plural fins spaced in the left-right direction and also extending in the vertical direction in parallel with each other, and a coupling link extending in the left-right direction and rotatably coupled to these fins.

The central fin of the blow outlet side fin assembly is provided with an operating knob and when this operating knob is gripped and moved in the vertical direction, the central fin is swung and also the other fins are swung through the coupling link and thereby, a blow direction can be adjusted in the vertical direction.

The operating knob is slidable in the left-right direction and is engaged with the central fin of the back side fin assembly. When this operating knob is slid in the left-right direction, the central fin of the back side fin assembly is swung and also the other fins are swung through the coupling link and thereby, the blow direction can be adjusted in the left-right direction.

In the register apparatus of JP-A-2007-076481, the blow direction of air can be changed, but all the fins are formed in parallel in each of the fin assemblies, with the result that the air is blown in a narrow angle range (spot blowing), and a crew may feel uncomfortable.

A register apparatus of JP-A-2009-292459 has a function capable of selecting a spot blowing mode of blowing air with plural fins formed in substantially parallel and a diffusion blowing mode of increasing an angle range of blowing. Concretely, the register apparatus includes a cylindrical cam member made by forming plural (the number equal to that of fins) cam grooves on a peripheral surface, plural (the number equal to that of fins) sliders slidably supported in the cam member in its longitudinal direction, and an actuator for rotating and driving the cam member. The sliders have projections fitted into the cam grooves. The plural sliders are formed with engaging grooves in parallel with each other, and projections of the fins are fitted into the engaging grooves. The projections of these fins are positioned in the back side from its swing axis line.

In the register apparatus of JP-A-2009-292459, when the cam member is rotated by driving the actuator, in a predetermined angle range, all the sliders are slid by the same amount and accordingly, all the fins are swung by the same angle. As a result, with the fins in parallel, the spot blowing is performed and a blow direction is adjusted. When the cam member is rotated in a different angle range, slide amounts of the plural sliders differ and accordingly, swing amounts of the plural fins differ, with the result that the plural fins are diffused so as to be mutually separated toward the vehicle room side, and the diffusion blowing is performed.

The register apparatus of JP-A-2009-292459 has a large number of components constructing a cam mechanism and a complicated and high-cost structure.

### SUMMARY

In accordance with embodiments, a vehicular register apparatus includes an apparatus body having a ventilation path with a downstream end provided as a blow outlet to a vehicle room. Fins are arranged in the ventilation path. The fins are spaced to each other in a first direction intersecting with an airflow direction. Each of the fins extends in a second direction intersecting with the airflow direction and the first direction. The fins respectively have shaft parts for supporting the fins on the apparatus body. The apparatus body includes guide passages for swingably and slidably supporting the shaft parts. The guide passages are formed so as to be apart in the first direction from each other toward the vehicle room.

### BRIEF DESCRIPTION OF THE DRAWINGS

FIG. 1 is a front view of a vehicular register apparatus according to a first embodiment, and shows a state in which a cover frame is omitted.

FIG. 2 is an exploded perspective view of the register apparatus, and shows a state in which a back side fin assembly is omitted.

FIG. 3 is a sectional view taken on arrow A-A of FIG. 1.

FIG. 4 is an enlarged plan view showing an upper side guide passage group of the register apparatus.

FIGS. 5A and 5B are enlarged plan views of a blow outlet side fin assembly of the register apparatus. FIG. 5A shows a state in which a spot blowing mode is performed. FIG. 5B shows a state in which a diffusion blowing mode is performed.

FIG. 6 is an enlarged plan view of an upper side guide passage group in a vehicular register apparatus according to a second embodiment.

FIGS. 7A and 7B are enlarged plan views of a blow outlet side fin assembly in the register apparatus of the second embodiment. FIG. 7A shows a state in which a spot blowing mode is performed. FIG. 7B shows a state in which a diffusion blowing mode is performed.

### DETAILED DESCRIPTION

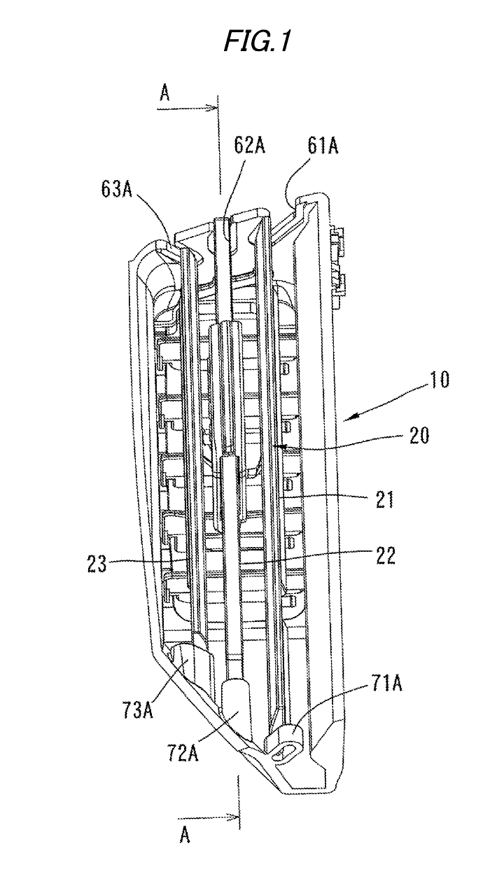

A first embodiment will hereinafter be described with reference to FIGS. 1 to 5. A register apparatus shown in FIGS. 1 to 3 is installed in a vehicular instrument panel (interior panel), and blows temperature-controlled air from an air conditioner toward a vehicle room. In the following description of the register apparatus, the front-back and left-right of the register apparatus are defined according to the front-back and left-right of a vehicle.

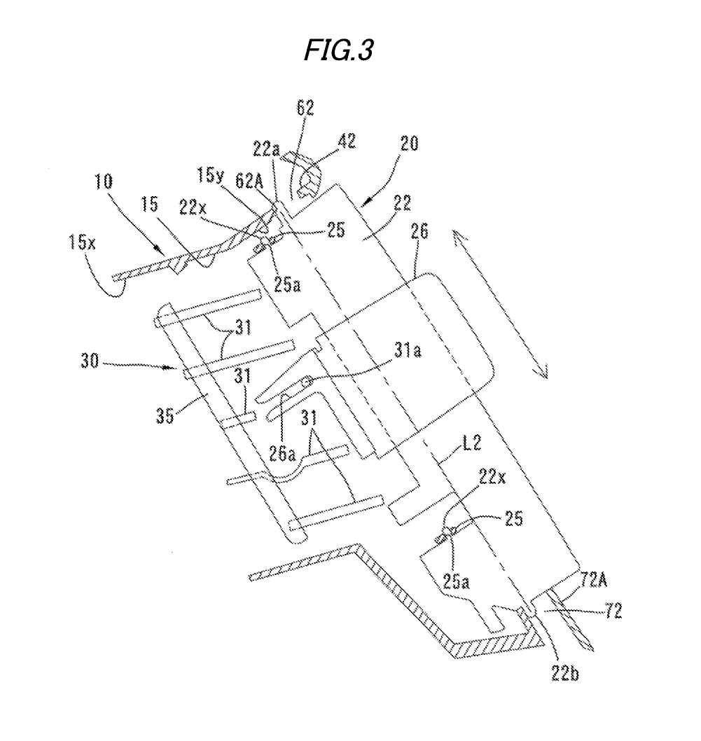

The register apparatus mainly includes an apparatus body 10 made of a tubular casing having a ventilation path 15 extending in a front-back direction, a blow outlet side fin assembly 20, and a back side fin assembly 30 (shown in only FIG. 3).

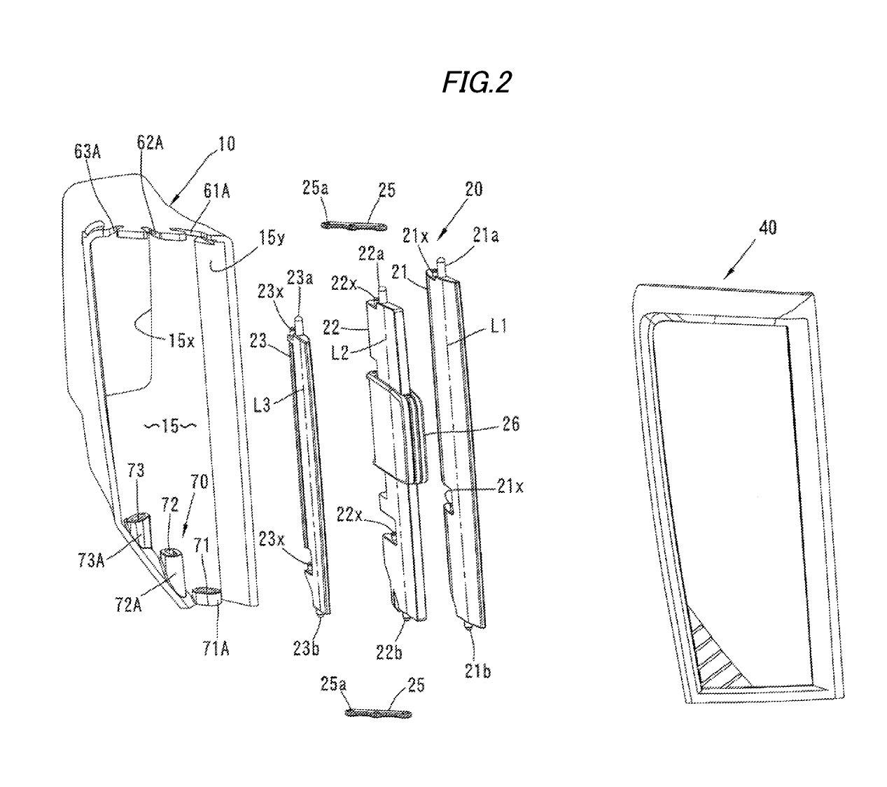

A cover frame 40 (shown in only FIG. 2) is attached to the instrument panel so as to cover a peripheral edge part of the apparatus body 10 from the vehicle room side.

The upstream end of the ventilation path 15 of the apparatus body 10 forms an air inlet 15x connected to a duct from the air conditioner, and the downstream end of the ventilation path 15 forms a blow outlet 15y.

The blow outlet side fin assembly 20 is arranged in the downstream side of the ventilation path 15, that is, the side of the blow outlet 15y, and the back side fin assembly 30 is arranged in the upstream side, that is, the back side from the blow outlet side fin assembly in the ventilation path 15.

The blow outlet side fin assembly 20 has plural (for example, three) fins 21, 22, 23, two coupling links 25 for coupling these fins 21, 22, 23, and an operating knob 26 supported in the central (intermediate) fin 22 (reference fin) slidably in its longitudinal direction. The fins 21, 22, 23 are mutually spaced in a left-right direction (first direction), and have elongated plate shapes extending in a vertical direction, more concretely, a direction (second direction) inclined to the front and back as shown in FIG. 3.

The upper ends of the fins 21, 22, 23 are respectively formed with shaft parts 21a, 22a, 23a (first shaft parts) and also, the lower ends of the fins are respectively formed with shaft parts 21b, 22b, 23b (second shaft parts). As described below, the fins 21, 22, 23 are respectively supported in the apparatus body 10 so as to be swingable around a swing axis line L1 passing through the shaft parts 21a, 21b, a swing axis line L2 passing through the shaft parts 22a, 22b, and a swing axis line L3 passing through the shaft parts 23a, 23b.

The fins 21, 22, 23 are respectively formed with projections 21x, 22x, 23x in two upper and lower places. These projections 21x, 22x, 23x are positioned in the backs from the swing axis lines L1, L2, L3, and are projected in parallel with these swing axis lines L1, L2, L3. Engaging holes 25a of the coupling links 25 are rotatably fitted into the upper and lower projections 21x, 22x, 23x, respectively, and thereby, the fins 21, 22, 23 are mutually coupled through the coupling links 25. A distance between the swing axis line L1 and the projection 21x of the fin 21, a distance between the swing axis line L2 and the projection 22x of the fin 22, and a distance between the swing axis line L3 and the projection 23x of the fin 23 are equal mutually.

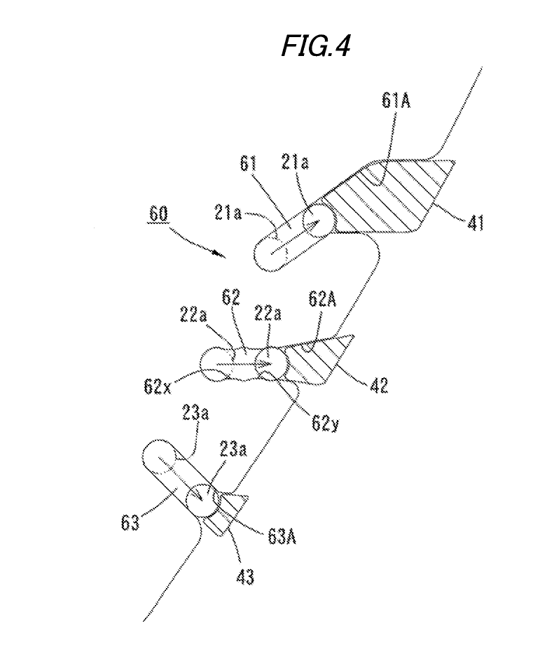

A support structure of the blow outlet side fin assembly 20 will be described. As shown in FIGS. 1 to 4, an upper wall of the apparatus body 10 is formed with slits 61A, 62A, 63A extending in the front-back direction while being separated in the left-right direction. As shown in FIG. 4, guide passages 61, 62, 63 of an upper side guide passage group 60 (first guide passage group) are formed by closing openings of the vehicle room side of these slits 61A, 62A, 63A by protrusions 41, 42, 43 formed on the cover frame 40.

The guide passages 61, 62, 63 have linear shapes but are not in parallel with each other, and are formed so as to gradually increase mutual distances from the back end toward the vehicle room side. More concretely, the central (intermediate) guide passage 62 (reference guide passage) extends along an axis line direction (airflow direction) of the ventilation path 15, and the left and right guide passages 61, 63 extend so as to be separated from the guide passage 62 toward the vehicle room in the left-right direction.

The shaft parts 21a, 22a, 23a of the upper ends of the fins 21, 22, 23 are rotatably and slidably inserted into the guide passages 61, 62, 63, respectively.

The central guide passage 62 has a narrowed part 62x (first narrowed part) for holding the shaft part 22a in the back end of the guide passage 62, and a narrowed part 62y (second narrowed part) for holding the shaft part 22a in the end of the vehicle room side in the guide passage 62. A passage width of each of these narrowed parts 62x, 62y is smaller than a diameter of each of the shaft parts 21a, 22a, 23a. In the present embodiment, the narrowed parts 62x, 62y are formed by small projections projected from both wall surfaces of the guide passage 62, but may be formed by small projections projected from one wall surface.

As shown in FIG. 2, the lower end of the apparatus body 10 is formed with protrusions 71A, 72A, 73A mutually separated in the left-right direction, and these protrusions 71A, 72A, 73A are respectively formed with slit-shaped guide passages 71, 72, 73 whose both ends are closed while extending in the front-back direction. A lower side guide passage group 70 (second guide passage group) is constructed by these guide passages 71, 72, 73.

When viewed from directions of the swing axis lines L1, L2, L3, the lower side guide passages 71, 72, 73 are respectively in positions overlapping with the corresponding upper side guide passages 61, 62, 63, and have substantially the same shape. Concretely, the guide passages 71, 72, 73 also have linear shapes but are not in parallel, and are formed so as to gradually increase mutual distances from the back end toward the vehicle room side, and the central guide passage 72 has first and second narrowed parts (not shown).

The shaft parts 21b, 22b, 23b of the lower ends of the fins 21, 22, 23 are rotatably and slidably inserted into the guide passages 71, 72, 73, respectively.

As shown in FIG. 3, the back side fin assembly 30 has plural (for example, five) fins 31 . . . , a coupling link 35 for coupling these fins 31 . . . . The fins 31 . . . are mutually spaced in the vertical direction, and have elongated plate shapes extending in the left-right direction. The fins 31 . . . are supported in left and right side walls of the apparatus body 10 so as to be swingable around a swing axis line horizontally extending in the left-right direction in substantially the center of a width direction of the fins 31 . . . . The coupling link 35 extends in the vertical direction, and is coupled in the vicinity of the back end of the fins 31 . . . rotatably around an axis line parallel to the swing axis line. The fins 31 . . . are in substantially parallel with each other.

The back side fin assembly 30 is interlocked with the operating knob 26. In brief, the back end of the operating knob 26 is formed with a slit 26a extending in the front-back direction, and a pin 31a extending in the left-right direction formed on the end of the vehicle room side in the central fin 31 is rotatably inserted into this slit 26a.

First, action of the back side fin assembly 30 will be described in the register apparatus having the above configuration. As shown in FIG. 3, when the operating knob 26 is slid in the vertical direction along the central fin 22, the pin 31a of the central fin 31 of the back side fin assembly 30 is moved in the vertical direction and with this movement, the central fin 31 is swung around the horizontal swing axis line and further, the other fins 31 are swung through the coupling link 35. As a result, a blow direction is adjusted in the vertical direction.

Next, action of the blow outlet side fin assembly 20 will be described.

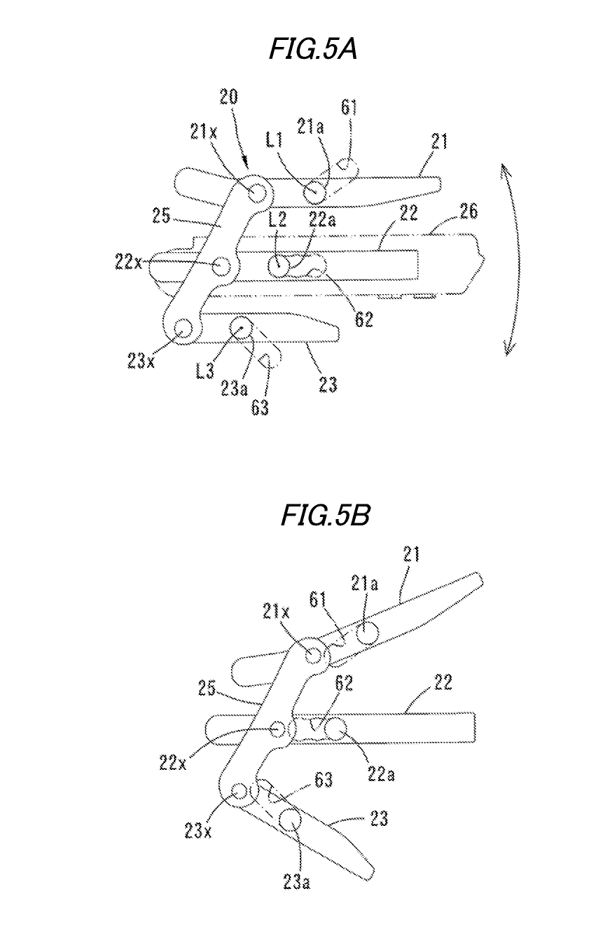

As shown in FIGS. 3 and 5A, in a state in which the shaft parts 21a, 21b of the fin 21 are positioned in the back end of the guide passages 61, 71 and the shaft parts 22a, 22b of the fin 22 are positioned in the back end of the guide passages 62, 72 and the shaft parts 23a, 23b of the fin 23 are positioned in the back end of the guide passages 63, 73, the fins 21, 22, 23 are in parallel with each other and the blow outlet side fin assembly 20 constructs a parallel link mechanism.

FIG. 5A shows a reference attitude along the axis line direction (airflow direction) of the ventilation path 15. In this reference attitude, air flowing through the ventilation path 15 is blown without being bent in the left-right direction.

When the operating knob 26 is gripped and moved in the left-right direction as shown by arrow of FIG. 5A, the central fin 22 is swung around the swing axis line L2 and the other fins 21, 23 are also swung around the swing axis lines L1, L3 through the coupling links 25. As a result, the blow direction can be adjusted in the left-right direction.

As shown in FIG. 5A, the fins 21, 22, 23 are maintained in parallel, with the result that the air is not diffused and is blown in the adjusted direction (spot blowing mode).

As shown by an imaginary line in FIG. 4, the shaft parts 22a, 22b are held in the back end by the first narrowed part 62x (a first narrowed part of the guide passage 72 is not shown) of the central guide passages 62, 72, with the result that the spot blowing mode can be maintained stably.

When the operating knob 26 is gripped and the central fin 22 is pulled out to the vehicle room side in the reference attitude of FIG. 5A, the shaft parts 22a, 22b of the central fin 22 are slid in the guide passages 62, 72 to reach the end of the vehicle room side as shown in FIG. 5B. The fin 22 is moved linearly toward the vehicle room with an attitude along the axis line of the apparatus body 10 maintained. When the fin 22 is pulled out, the fins 21, 23 are also moved to the vehicle room side through the coupling links 25. Accordingly, the shaft parts 21a, 21b of the fin 21 are slid in the guide passages 61, 71 to reach the end of the vehicle room side, and the shaft parts 23a, 23b of the fin 23 are slid in the guide passages 63, 73 to reach the end of the vehicle room side.

Since the guide passages 61, 62, 63 are formed so as to be separated toward the vehicle room and the guide passages 71, 72, 73 are formed similarly, when the fins 21, 22, 23 are pulled out toward the vehicle room, the shaft parts 21a, 22a, 23a are mutually separated in the left-right direction from the time of spot blowing, and the shaft parts 21b, 22b, 23b are also mutually separated in the left-right direction, with the result that the fins 21, 22, 23 change from a parallel state at the time of spot blowing to a state diffused toward the vehicle room as shown in FIG. 5B. As a result, air is blown in an angle range wide in the left-right direction (diffusion blowing mode), and a crew can receive mild blowing.

As described above, when the fin 22 is pulled out, the shaft part 22a passes through the narrowed parts 62x, 62y of the guide passage 62, and this passing is enabled by elastic deformation of the apparatus body 10 made of resin. The shaft part 22a reaching the end of the vehicle room side of the guide passage 62 is regulated by the narrowed part 62y and the shaft part 22b is similarly regulated in the end of the room inside of the guide passage 72, with the result that the diffusion blowing mode can be maintained stably.

When the operating knob 26 is pushed in a direction opposite to the above, the fins 21, 22, 23 are moved toward the back, and switching from the diffusion blowing mode to the spot blowing mode can be performed.

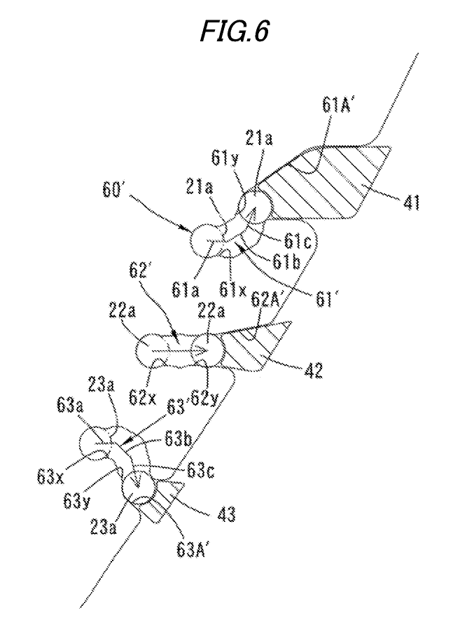

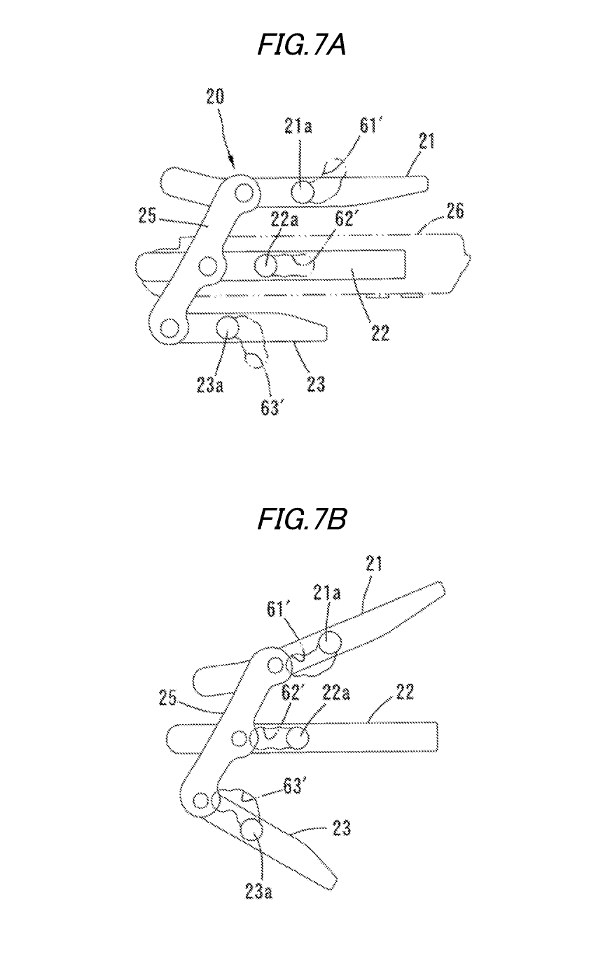

FIGS. 6, 7A and 7B show a register apparatus according to a second embodiment. In the second embodiment, the same numeral or the same numeral with “′” is assigned to a component corresponding to that of the first embodiment and its detailed description is omitted.

A central guide passage 62′ has a linear shape and extends along an airflow direction like the guide passage 62 of the first embodiment, but guide passages 61′, 63′ of both sides have bent shapes. Hereinafter, detailed description will be made.

As shown in FIG. 6, the guide passages 61′, 63′ of both sides are respectively constructed by joining back side passage portions 61a, 63a, intermediate passage portions 61b, 63b, and vehicle room side passage portions 61c, 63c. The back side passage portions 61a, 63a are in parallel with the central guide passage 62′. The intermediate passage portions 61b, 63b are inclined to the central guide passage 62′ so as to be mutually separated in the left-right direction toward the vehicle room. The vehicle room side passage portions 61c, 63c are also inclined to the central guide passage 62′ so as to be mutually separated in the left-right direction toward the vehicle room, but angles of inclination of the vehicle room side passage portions 61c, 63c are larger than angles of inclination of the intermediate passage portions 61b, 63b.

In the second embodiment, like the central guide passage 62′, the guide passages 61′, 63′ of both sides have first narrowed parts 61x, 63x and second narrowed parts 61y, 63y, respectively.

A lower side guide passage group (not shown) is similarly constructed.

In the configuration described above, switching between a spot blowing mode shown in FIG. 7A and a diffusion blowing mode shown in FIG. 7B is similar to that of the first embodiment, with the result that the detailed description is omitted. However, in the present embodiment, when an operating knob 26 is gripped and a central fin 22 and fins 21, 23 of both sides are pulled out, the back side passage portions 61a, 63a of the guide passages 61′, 63′ of both sides are in parallel with the central guide passage 62′, with the result that there is no resistance except the narrowed parts 61x, 62x, 63x, and initial operation is facilitated. When the fins are further pulled out, the operation resistance is increased stepwise.

The same applies to action of lower side guide passages and lower side shaft parts of the fins 21, 22, 23.

In the second embodiment, each of the guide passages 61′, 63′ may be curved in a curved shape, or may be constructed of only the back side passage portion and the vehicle room side passage portion excluding the intermediate passage portion.

Also, the back side passage portions 61a, 63a of the guide passages 61′, 63′ of both sides may be inclined to the central guide passage 62′ so as to be mutually separated toward the vehicle room side. In this case, angles of inclination of the back side passage portions 61a, 63a to the central guide passage 62′ are made smaller than angles of inclination of the intermediate passage portions 61b, 63b to the central guide passage 62′.

Embodiments are not limited to the exemplary embodiments described above and further, various aspects can be implemented.

In the exemplary embodiments described above, the casing used as the apparatus body is formed with the guide passage, but the apparatus body may be constructed of a casing and a guide member attached to this casing to form this guide member with a guide passage.

In the exemplary embodiments described above, the shaft parts of both ends of the fin, that is, the first and second shaft parts are slid along the guide passages of the first and second guide passage groups, but the apparatus body may be formed with only the first guide passage group for guiding one shaft part, for example, the first shaft part. In this case, the second shaft part which is the other shaft part is rotatably supported in a hole formed in the apparatus body. In this configuration, when the fins are pulled out, the first shaft part is slid along the guide passages of the first guide passage group with the second shaft part held in the hole and thereby, the fins are diffused toward the vehicle room while being inclined.

When many fins are mounted and many guide passages are formed, for example, two intermediate guide passages may extend parallel.

The number of coupling links 25 may be one.

It may be constructed so that the blow outlet side fin assembly adjusts a wind direction in the vertical direction and the back side fin assembly adjusts the wind direction in the left-right direction. In this case, it is constructed so that the blow outlet side fin assembly includes plural fins which extend in the left-right direction and are spaced in the vertical direction and when the fins are pulled out to the vehicle room side, the fins are guided to guide passages formed in left and right walls of the apparatus body and are diffused in the vertical direction.

The number of fins of the blow outlet side fin assembly is not limited and also, the shape of the apparatus body is not limited.

The back side fin assembly may be omitted.

The invention would be applicable to a register apparatus for air conditioning of a vehicle.

In accordance with embodiments, a vehicular register apparatus 1 includes an apparatus body 10 and a fin assembly 20. The apparatus body 10 includes a ventilation path 15. The ventilation path 15 has an upstream end connected to an air conditioner and a downstream end provided as a blow outlet to a vehicle room. The fin assembly 20 is arranged in the ventilation path 15. The fin assembly 20 includes a plurality of fins 21, 22, 23. The plurality of fins 21, 22, 23 are spaced to each other in a first direction intersecting with an airflow direction in the ventilation path 15, each of the plurality of fins 21, 22, 23 extends in a second direction intersecting with the airflow direction and the first direction. The plurality of fins 21, 22, 23 respectively have first and second shaft parts 21a, 22a, 23a, 21b, 22b, 23b on both ends of the fins 21, 22, 23 in the second direction. The plurality of fins 21, 22, 23 are swingably supported on the apparatus body 10 through these first and second shaft parts 21a, 22a, 23a, 21b, 22b, 23b. A coupling link 25 which extends in the first direction is rotatably coupled to the plurality of fins 21, 22, 23. Each of the plurality of fins 21, 22, 23 is coupled to the coupling link 25 in a back side from a swing axis line passing through the corresponding first and second shaft parts 21a, 22a, 23a, 21b, 22b, 23b. The apparatus body 10 includes a plurality of guide passages 61, 62, 63, 61′, 62′, 63′, 71, 72, 73 that swingably and slidably support at least ones of the first and second shaft parts 21a, 22a, 23a, 21b, 22b, 23b of the respective plurality of fins 21, 22, 23. The plurality of guide passages 61, 62, 63, 61′, 62′, 63′, 71, 72, 73 are formed so as to be apart in the first direction from each other toward the vehicle room.

According to the configuration described above, the fins would be switched from a spot blowing mode to a diffusion blowing mode by pulling out the one fin of the fin assembly toward the vehicle room, and the fins would be switched from the diffusion blowing mode to the spot blowing mode by pushing in the fin toward the back. Thus, the blowing mode would be switched by simple operation. Also, in the case of switching to the diffusion blowing mode, the fins are diffused while being moved near to the blow outlet, with the result that a diffusion effect of blowing would be increased. Moreover, in a configuration for switching of the blowing mode, the apparatus body has only to be formed with the guide passages, with the result that the configuration is simple and low-cost.

The apparatus body 10 may include a first guide passage group 60, 60′ including the plurality of guide passages 61, 62, 63, 61′, 62′, 63′ that swingably and slidably support the first shaft parts 21a, 22a, 23a of the respective plurality of fins 21, 22, 23, and a second guide passage group 70 including the plurality of guide passages 71, 72, 73 that swingably and slidably support the second shaft parts 21b, 22b, 23b of the respective plurality of fins 21, 22, 23.

According to the configuration described above, in the case of switching of the blowing mode, both ends of the fins are moved, with the result that stable switching operation would be implemented and further, the diffusion effect of blowing would be increased more.

The plurality of fins may include a reference fin 22 intermediately positioned in the first direction, and fins 21, 23 positioned in both sides of the reference fin 22. The plurality of guide passages 61, 62, 63, 61′, 62′, 63′, 71, 72, 73 of each of the first and second guide passage groups 60, 60′, 70 may include a reference guide passage 62, 62′, 72 intermediately positioned in the first direction, and guide passages 61, 61′, 63, 63′, 71, 73 positioned in both sides of the reference guide passage 62, 62′, 72, corresponding to the reference fin 22 and the fins 21, 23 of both sides. The reference guide passage 62, 62′, 72 may extend linearly along the airflow direction. The guide passages 61, 61′, 63, 63′, 71, 73 of both sides may be mutually separated in opposite directions from the reference guide passage toward the vehicle room.

According to the configuration described above, the blowing mode would smoothly be switched by moving the reference fin substantially linearly.

In each of the first and second guide passage groups 60, 60′, 70, at least the reference guide passage 62, 62′, 72 may have a first narrowed part 62x that regulates corresponding one of first and second shaft parts 22a, 22b of the reference fin 22 in a back end of the reference guide passage 62, 62′, 72, and a second narrowed part 62y that regulates the corresponding one of first and second shaft part 22a, 22b in an end of a vehicle room side in the guide passage 62, 62′, 72. Passage widths of the first and second narrowed parts 62x, 62y may be smaller than diameters of the corresponding one of the first and second shaft parts 22a, 22b. The corresponding one of the first and second shaft parts 22a, 22b may be capable of passing through the first and second narrowed parts 62x, 62y with elastic deformation of the apparatus body 10.

According to the configuration described above, the spot blowing mode would stably be maintained by the first narrowed part, and the diffusion blowing mode would stably be maintained by the second narrowed part.

The reference fin 22 may be provided with an operating knob 26.

According to the configuration described above, switching of the blowing mode and adjustment of wind direction in the spot blowing mode would be performed by gripping the operating knob and operating the reference fin.

In each of the first and second guide passage groups 60, 60′, 70, all of the plurality of guide passages 61, 62, 63, 61′, 62′, 63′, 71, 72, 73 may extend linearly.

According to the configuration described above, the fin assembly would smoothly be moved in a process of switching of the mode.

In each of the first and second guide passage groups 60, 60′, 70, a back side passage portion 61a, 63a of each of the guide passages 61, 61′, 63, 63′, 71, 73 of both sides may be in parallel with the reference guide passage 62, 62′, 72 or may have a small angle of inclination to the reference guide passage, and a vehicle room side passage portion 61c, 63c of each of the guide passages 61, 61′, 63, 63′, 71, 73 of both sides may have an angle of inclination to the reference guide passage 62, 62′, 72 larger than that of the back side passage portion 61a, 63a.

According to the configuration described above, initial operation would be facilitated in the case of switching from the spot blowing mode to the diffusion blowing mode.

In each of the first and second guide passage groups 60, 60′, 70, each of the guide passages 61, 61′, 63, 63′, 71, 73 of both sides may have an intermediate passage portion 61b, 63b between the back side passage portion 61a, 63a and the vehicle room side passage portion 61c, 63c. The intermediate passage portion 61b, 63b may have the angle of inclination to the reference guide passage 62, 62′, 72 larger than that of the back side passage portion 61a, 63a and smaller than that of the vehicle room side passage portion 61c, 63c.

According to the configuration described above, operation resistance would be increased in a process of switching from the spot blowing mode to the diffusion blowing mode.

The vehicular register apparatus 1 may further include a back side fin assembly 30 arranged in a back side of the fin assembly 20 in the ventilation path. The back side fin assembly 30 may have a plurality of back side fins 31 which are spaced to each other in the second direction. Each of the plurality of back side fins 31 may be swingably supported in the apparatus body 10 around a swing axis line extending in the first direction. A coupling link 35 extending in the second direction may be rotatably coupled to the respective plurality of back side fins 31. The operating knob 26 may be slidable in the second direction on the reference fin 22. The operating knob 26 may be interlocked with one of the plurality of back side fins 31.

According to the configuration described above, switching of the blowing mode and adjustment of wind direction of two directions (for example, a left-right direction and a vertical direction) in the spot blowing mode would be performed by operation of the operating knob.

In accordance with the embodiments, it would be possible to switch between the spot blowing mode and the diffusion blowing mode by a simple structure and simple operation.

### DESCRIPTION OF REFERENCE NUMERALS AND SIGNS

1 REGISTER APPARATUS
10 APPARATUS BODY
15 VENTILATION PATH
15y BLOW OUTLET
20 BLOW OUTLET SIDE FIN ASSEMBLY
21,22,23 FIN
21a,22a,23a UPPER SIDE SHAFT PART (FIRST SHAFT PART)
21b,22b,23b LOWER SIDE SHAFT PART (SECOND SHAFT PART)
25 COUPLING LINK
30 BACK SIDE FIN ASSEMBLY
31 FIN
35 COUPLING LINK
60,60′ UPPER SIDE GUIDE PASSAGE GROUP (FIRST GUIDE PASSAGE GROUP)
61,62,63,61′,62′,63′ UPPER SIDE GUIDE PASSAGE
61a,63a BACK SIDE PASSAGE PORTION
61b,63b INTERMEDIATE PASSAGE PORTION
61c,63c VEHICLE ROOM SIDE PASSAGE PORTION
62x FIRST NARROWED PART
62y SECOND NARROWED PART
70 LOWER SIDE GUIDE PASSAGE GROUP (SECOND GUIDE PASSAGE GROUP)
71,72,73 LOWER SIDE GUIDE PASSAGE

What is claimed is:

1. A vehicular register apparatus comprising:
an apparatus body; and
a fin assembly,
wherein the apparatus body includes a ventilation path,
wherein the ventilation path has an upstream end connected to an air conditioner and a downstream end provided as a blow outlet to a vehicle room,
wherein the fin assembly is arranged in the ventilation path,
wherein the fin assembly includes a plurality of fins,
wherein the plurality of fins are spaced to each other in a first direction intersecting with an airflow direction in the ventilation path, wherein each of the plurality of fins extends in a second direction intersecting with the airflow direction and the first direction,
wherein the plurality of fins respectively have first and second shaft parts on both ends of the fins in the second direction,
wherein the plurality of fins are swingably supported on the apparatus body through these first and second shaft parts,
wherein a coupling link which extends in the first direction is rotatably coupled to the plurality of fins,
wherein each of the plurality of fins is coupled to the coupling link in a back side from a swing axis line passing through the corresponding first and second shaft parts,
wherein the apparatus body includes a plurality of guide passages that swingably and slidably support at least ones of the first and second shaft parts of the respective plurality of fins, and
wherein the plurality of guide passages are formed so as to be apart in the first direction from each other toward the vehicle room.

2. The vehicular register apparatus according to claim 1, wherein the apparatus body includes:
a first guide passage group including the plurality of guide passages that swingably and slidably support the first shaft parts of the respective plurality of fins; and
a second guide passage group including the plurality of guide passages that swingably and slidably support the second shaft parts of the respective plurality of fins.

3. The vehicular register apparatus according to claim 2, wherein the plurality of fins include a reference fin intermediately positioned in the first direction, and fins positioned in both sides of the reference fin,
wherein the plurality of guide passages of each of the first and second guide passage groups include a reference guide passage intermediately positioned in the first direction, and guide passages positioned in both sides of the reference guide passage, corresponding to the reference fin and the fins of both sides,
wherein the reference guide passage extends linearly along the airflow direction, and
wherein the guide passages of both sides are mutually separated in opposite directions from the reference guide passage toward the vehicle room.

4. The vehicular register apparatus according to claim 3, wherein in each of the first and second guide passage groups, at least the reference guide passage has a first narrowed part that regulates corresponding one of first and second shaft parts of the reference fin in a back end of the reference guide passage, and a second narrowed part that regulates the corresponding one of first and second shaft part in an end of a vehicle room side in the guide passage,
wherein passage widths of the first and second narrowed parts are smaller than diameters of the corresponding one of the first and second shaft parts, and
wherein the corresponding one of the first and second shaft parts is capable of passing through the first and second narrowed parts with elastic deformation of the apparatus body.

5. The vehicular register apparatus according to claim 3, wherein the reference fin is provided with an operating knob.

6. The vehicular register apparatus according to claim 2, wherein in each of the first and second guide passage groups, all of the plurality of guide passages extend linearly.

7. The vehicular register apparatus according to claim 3, wherein in each of the first and second guide passage groups, a back side passage portion of each of the guide passages of both sides is in parallel with the reference guide passage or has a small angle of inclination to the reference guide passage, and a vehicle room side passage portion of each of the guide passages of both sides has an angle of inclination to the reference guide passage larger than that of the back side passage portion.

8. The vehicular register apparatus according to claim 7, wherein in each of the first and second guide passage groups, each of the guide passages of both sides has an intermediate passage portion between the back side passage portion and the vehicle room side passage portion, and
wherein the intermediate passage portion has the angle of inclination to the reference guide passage larger than that of the back side passage portion and smaller than that of the vehicle room side passage portion.

9. The vehicular register apparatus according to claim 5, further comprising:
a back side fin assembly arranged in a back side of the fin assembly in the ventilation path,
wherein the back side fin assembly has a plurality of back side fins which are spaced to each other in the second direction,
wherein each of the plurality of back side fins is swingably supported in the apparatus body around a swing axis line extending in the first direction,
wherein a coupling link extending in the second direction is rotatably coupled to the respective plurality of back side fins,
wherein the operating knob is slidable in the second direction on the reference fin, and
wherein the operating knob is interlocked with one of the plurality of back side fins.
